(19) United States
(12) Patent Application Publication
(10) Pub. No.: US 2026/0211863 A1
(43) Pub. Date: Jul. 23, 2026

(54) PROCESSING CONTROL OF DATA ELEMENTS IN DATA PROCESSING SYSTEMS

(71) Applicant: Arm Limited, Cambridge (GB)

(72) Inventors: Jakob Axel FRIES, Lund (SE); Olof Henrik UHRENHOLT, Lomma (SE)

(73) Assignee: Arm Limited, Cambridge (GB)

(21) Appl. No.: 19/033,326

(22) Filed: Jan. 21, 2025

(51) Int. Cl. G06F 16/22

(52) U.S. Cl. CPC G06F 16/2255; G06F 16/2237

(57) ABSTRACT

A data processing system is disclosed that includes storage storing an array of data elements. In response to a request to process an item, a hash function is implemented to map an identifier identifying the item to a data element of the array of data elements. A data value of the data element of the array of data elements is used to determine whether the request to process the item can be granted, and the item is allowed to be processed when it is determined that the request to process the item can be granted.

### BACKGROUND

The technology described herein relates to data processing systems and data processors, such as graphics processing systems and graphics processors (GPUS).

Data processing systems and data processors may make use of a mutex to prevent more than one process processing the same item (e.g. data) at the same time. Similarly, a semaphore may be used to prevent more than a maximum number of processes processing the same item (e.g. data) at the same time.

The inventors believe that there remains scope for improvements to implementing mutexes and semaphores in data processing systems and data processors.

### BRIEF DESCRIPTION OF THE DRAWINGS

Embodiments of the technology described herein will now be described by way of example only and with reference to the accompanying drawings, in which:

FIG. 1 shows an exemplary graphics processing system in which the technology described herein may be implemented;

FIG. 2 shows schematically an exemplary data processor;

FIG. 3 shows schematically a data processor in accordance with embodiments of the technology described herein;

FIG. 4A and FIG. 4B show schematically a mutex handling arrangement in accordance with embodiments of the technology described herein;

FIG. 5 is a flow chart showing a process for acquiring a mutex in accordance with embodiments of the technology described herein;

FIG. 6 is a flow chart showing a process for releasing a mutex in accordance with embodiments of the technology described herein;

FIG. 7 shows schematically a mutex handling arrangement in accordance with embodiments of the technology described herein;

FIG. 8 shows schematically a graphics processor in accordance with an embodiment of the technology described herein;

FIG. 9 is a flow chart showing a process that the graphics processor of FIG. 8 may use to evict a compression block in accordance with embodiments of the technology described herein;

FIG. 10 is a flow chart showing a read-modify-write process that the graphics processor of FIG. 8 may perform in accordance with embodiments of the technology described herein;

FIG. 11 shows schematically a data processor in accordance with an embodiment of the technology described herein; and

FIG. 12 shows schematically a semaphore handling arrangement in accordance with embodiments of the technology described herein.

### DETAILED DESCRIPTION

A first embodiment of the technology described herein comprises a data processing system comprising:
storage operable to store an array of data elements; and
a control circuit operable to implement a hash function that maps identifiers identifying items to data elements of the array of data elements;
wherein the control circuit is operable to, in response to a request to process an item (e.g. data), wherein the request indicates an identifier identifying the item:
   implement the hash function to map the identifier identifying the item to a data element of the array of data elements;
   use a data value of the data element of the array of data elements to determine whether the request to process the item can be granted; and
   allow the request to process the item when it is determined that the request to process the item can be granted.

A second embodiment of the technology described herein comprises a method of operating a data processing system that comprises storage operable to store an array of data elements;
the method comprising, in response to a request to process an item (e.g. data), wherein the request indicates an identifier identifying the item:
   implementing a hash function to map the identifier identifying the item to a data element of the array of data elements;
   using a data value of the data element of the array of data elements to determine whether the request to process the item can be granted; and
   allowing the request to process the item when it is determined that the request to process the item can be granted.

The technology described herein relates to a data processing system, such as a graphics processing system. In particular, embodiments relate to the situation in which it is possible for items (e.g. processing entities) to be processed by two or more (different) processes (e.g. processing circuits of the data processing system), but where it is desirable to prevent more than one (or another maximum number) of the processes (processing circuits) from processing the same item (e.g. data) at the same time. For example, where different processes (processing circuits) are to process the same processing item, it may be desirable to serialise processing of the item by the different processes (processing circuits).

Put another way, embodiments of the technology described herein relate to implementing a mutex or semaphore arrangement in a data processing system.

Such a situation may occur, for example and in embodiments, where a data processing system (e.g. graphics processing system) has plural block-based (compression) encoders that are able to encode (compress) the same compression block(s) (compression unit(s), “CU”), but where only one of the encoders should be allowed to encode a given compression block at any one time, e.g. as described in United Kingdom Patent Application No. 2118631.7 or United Kingdom Patent Application No. 2405981.8, the entire contents of which is hereby incorporated herein by reference.

In embodiments of the technology described herein, when a processing circuit (e.g. encoder) wants to process (e.g. encode) a processing item (e.g. compression block) that can be processed (e.g. encoded) by plural different processing circuits (e.g. encoders), a request is issued (e.g. by the processing circuit) which indicates an identifier that identifies the item in question. The identifier may, for example and in embodiments, comprise an (memory) address for the item (e.g. compression block).

In the technology described herein, the data processing system is provided with storage storing an array of data elements, and a hash function that maps identifiers (e.g. memory addresses) identifying the items (e.g. compression blocks) to the data elements of the array. As will be discussed in more detail below, the array of data elements may be an array of bits e.g. in the case of a mutex arrangement, and an array of counters e.g. in the case of a semaphore arrangement.

In response to a request to process (e.g. encode) a processing item (e.g. compression block), the identifier (e.g. memory address) identifying the item (e.g. compression block) is mapped to a data element (e.g. bit) of the array of data elements (e.g. array of bits) by the hash function, and the data value (e.g. bit value) of that data element (e.g. bit) is used to determine whether or not the request can be granted. Requests should be, and in embodiments are, allowed/granted (by the control circuit) such that only one process/processing circuit (or another maximum number of processes/processing circuits) is allowed to process the same item at the same time.

In embodiments, when it is determined that the request to process the item (e.g. compression block) can be granted, the request is allowed and the processing item (e.g. compression block) is processed (e.g. encoded), and when it is not determined that the request to process the item (e.g. compression block) can be granted (when it is determined that the request to process the processing item cannot be granted), the request is not allowed and the item (e.g. compression block) is not processed (e.g. encoded), e.g. the request may be stalled until it is subsequently allowed.

As will be discussed in more detail below, the inventors have found that an amount of storage required to store the array of data elements (e.g. array of bits) in this manner can be significantly less than that required to (directly) store the identifiers (e.g. memory addresses) themselves. Thus, hashing the identifiers (e.g. memory addresses) to an array of data elements (e.g. array of bits) in this manner can significantly reduce an amount of storage required to implement a mutex or semaphore arrangement, e.g. as compared to arrangements that directly store the identifiers (e.g. memory addresses). This can reduce overall hardware/silicon area costs and energy consumption associated with implementing a mutex or semaphore arrangement in a data processing system.

It will be appreciated, therefore, that the technology described herein provides an improved data processing system.

The data processing system should, and in embodiments does, comprise one or more data processing units (data processors), such as one or more of: a central processing unit (CPU), a graphics processing unit (GPU) (graphics processor), a video processor, a sound processor, an image signal processor (ISP), a digital signal processor (DSP), a neutral network processor, a display controller, a compression codec unit (e.g. as described in WO 2022/157510), or another type of data processing unit.

In embodiments, the data processing system is a graphics processing system that comprises one or more graphics processing units (GPUs) (graphics processors). The system may further comprise a host processor, e.g. a central processing unit (CPU). The host processor (e.g. CPU) may execute applications that can require graphics processing by the one or more graphics processors (GPU), and send appropriate commands and data to the one or more graphics processors (GPUs) to control them to perform graphics processing operations and to produce graphics processing (render) output required by applications executing on the host processor (e.g. CPU).

To facilitate this, the host processor (e.g. CPU) may also execute a driver for the one or more graphics processors (GPUs). Thus, in embodiments, the data processing system comprises a graphics processor (GPU) that is in communication with a host microprocessor (CPU) that executes a driver for the graphics processor (GPU).

The data (e.g. graphics) processing system should, and in embodiments does, comprise a memory system that the one or more data processing units can access, e.g. read from and/or write to. The memory system may comprise any suitable and desired memory for storing any suitable data that the data processing system uses and/or produces, such as image data, texture data, graphics processing fragment or vertex data, video data, sound data, neural network data, etc. In embodiments, the system comprises (at least) a main (system) memory that is, in embodiments, an external memory, e.g. not on the same chip as the one or more data processing units. The memory system may (further) comprise a cache system (hierarchy), e.g. via which the one or more data processing units can communicate with the (main) memory.

A (each) operation of the technology described herein may be performed by any one or more data processing units of the system, such as the graphics processor (GPU), and/or host processor (CPU), and/or another component of the data processing system, as appropriate. Correspondingly, a (each) circuit of the technology described herein may form part of a data processing unit (data processor), e.g. the graphics processor (GPU), and/or host processor (CPU), and/or another component of the graphics processing system, as appropriate.

Thus, another embodiment of the technology described herein comprises a data processor (data processing unit) comprising:
storage operable to store an array of data elements; and
a control circuit operable to implement a hash function that maps identifiers identifying items to data elements of the array of data elements;
wherein the control circuit is operable to, in response to a request to process an item (e.g. data), wherein the request indicates an identifier identifying the item:
   implement the hash function to map the identifier identifying the item to a data element of the array of data elements;
   use a data value of the data element of the array of data elements to determine whether the request to process the item can be granted; and
   allow the request to process the item when it is determined that the request to process the item can be granted.

Another embodiment of the technology described herein comprises a method of operating a data processor (data processing unit) that comprises storage operable to store an array of data elements;
the method comprising, in response to a request to process an item (e.g. data), wherein the request indicates an identifier identifying the item:
   implementing a hash function to map the identifier identifying the item to a data element of the array of data elements;
   using a data value of the data element of the array of data elements to determine whether the request to process the item can be granted; and
   allowing the request to process the item when it is determined that the request to process the item can be granted.

These embodiments can, and in embodiments do, include any one or more or all of the optional features described herein, as appropriate. For example, the data processor may be a central processing unit (CPU), a graphics processing unit (GPU) (graphics processor), a compression codec unit, etc.

A (the) data processor (data processing unit) can be arranged in any suitable manner. The data processor may comprise one or more, e.g. plural, processing cores (e.g. shader cores). A (each) processing core may be operable to perform data processing operations by executing (e.g. shader) program instructions. There may be any suitable number of processing cores, such as 1, 2, 4, 8, 16, 32 or another number. In embodiments, a (each) processing core comprises one or more execution units (execution engines) that are operable to execute program instructions.

The data processor may be in direct communication with the memory, or may communicate with the memory via a (the) cache system. In embodiments, the data processor comprises a cache system that is operable to cache data stored in the memory for the data processor.

The cache system may be a single level cache system, or a multi-level cache system. In embodiments, the cache system comprises one or more, e.g. plural, lower-level (e.g. L1) caches and a higher-level (e.g. L2) cache. A (the) higher-level (e.g. L2) cache may be in communication with the memory and each of the one or more, e.g. plural, lower-level (e.g. L1) caches. A (each) lower-level (e.g. L1) cache may be in communication with the higher-level (e.g. L2) cache and a (respective) processing core of the one or more, e.g. plural, processing cores. Thus, in embodiments, the data processor comprises as many lower-level (e.g. L1) caches as processing cores. The cache system may comprise one or more further cache levels, such as a level 0 (L0) and/or level 3 (L3) cache, etc.

The items can be any suitable processing items/entities that can be processed in any suitable manner. An item should be, and in embodiments is, a resource, such as a set of data, that can only be processed once a request to process the item (e.g. set of data) has been granted (by the control circuit), e.g. and that should only be processed by one process/processing circuit (or another maximum number of processes/processing circuits) at any one time.

In embodiments, a (each) processing item is a (respective) region of a data array, such as an image array, e.g. that can be processed independently of other regions of the data (e.g. image) array. Thus, in embodiments, a data array (e.g. image array) is divided into (independently processable) processing regions, each of which can (only) be processed once an appropriate request has been granted (by the control circuit). As will be discussed below, each such processing region may be a compression block (compression unit, “CU”) of a block-based encoding scheme. The processing regions/compression blocks may be non-overlapping, and/or may be all the same size and shape, and/or may be rectangular, such as square.

In embodiments, when it is desired to process an item (e.g. set of data/processing region/compression block), a request to process the item is issued, wherein the request indicates an identifier identifying the item to be processed. In embodiments, once a request to process an item has been issued, a response to the request (e.g. a signal from the control circuit) is awaited before the item can be (and is) processed. In embodiments, in response to a signal (from the control circuit) indicating that a request to process an item is allowed/granted, processing of the item can (and does) begin. In embodiments, once processing of an item has been completed, a signal is issued (to the control circuit) indicating that processing of the item is complete, wherein the signal indicates an identifier identifying the item.

A (the) signal/request to process an item (e.g. set of data/processing region/compression block) can originate from any suitable process/circuit of the data processing system or data processor. In embodiments, the data processing system or data processor comprises two or more processing circuits that are operable to process (at least some of) the same processing items. In embodiments, a (the) request to process an item is a request for/by a processing circuit of the two or more processing circuits to process an item that can be processed by the two or more processing circuits. Correspondingly, in embodiments, a request to process an item is allowed/granted (by the control circuit) by allowing a processing circuit of the two or more processing circuits to process the processing item. In embodiments, the control circuit allows only one processing circuit (or another maximum number of processing circuits) of the two or more processing circuits to process any one item (that can be processed by the two or more processing circuits) at the same time.

The two or more processing circuits can be any suitable processing circuits/processes that process (the same) processing items (e.g. data/region/block). The two or more processing circuits should be, and in embodiments are, the same type of processing circuits/processes that can process the same type of items in the same way.

In embodiments, a (each) processing circuit is operable to, when it is to process an item (that can be processed by the two or more processing circuits), issue a (the) request (to the control circuit) to process the item, wherein the request indicates an identifier identifying the item to be processed. In embodiments, a (each) processing circuit is operable to, once it has issued a request to process an item, wait for a response to the request (from the control circuit) before processing the item. In embodiments, a (each) processing circuit is operable to, in response to a signal (from the control circuit) indicating that the processing circuit can process an item, begin processing the item. In embodiments, a (each) processing circuit is operable to, once it has completed processing an item, issue a signal (to the control circuit) indicating that processing of the item is complete, wherein the signal indicates an identifier identifying the item.

In embodiments, a (each) processing core of the data processor is or is associated with, e.g. comprises, a (respective) processing circuit of the two or more processing circuits. Thus, in embodiments, the data processor comprises as many processing circuits as processing cores.

In embodiments, the two or more processing circuits are or comprise two or more (compression) codecs, e.g. each comprising a (compression) encoder and/or a (compression) decoder. A (each) processing circuit may thus be operable to encode and/or decode (e.g. compress and/or decompress) data, e.g. in accordance with a suitable encoding scheme.

In embodiments, the encoding (compression) scheme is block-based. Thus, in embodiments, a (each) processing circuit is operable to encode and/or decode (e.g. compress and/or decompress) compression blocks of data that an array of data (e.g. an image array) is divided into. Correspondingly, in embodiments, a (each) processing item is a compression block (compression unit, “CU”) of an array of data (e.g. image array) that the data processor/system is processing. Thus, in embodiments, there are plural encoders that are able to encode at least some of the same compression blocks of a data array (e.g. image array) being generated.

Thus, another embodiment of the technology described herein comprises a data processing system or data processor comprising:
two or more encoders operable to encode compression blocks of a data array;
storage operable to store an array of data elements; and
a control circuit operable to implement a hash function that maps identifiers identifying compression blocks of the data array to data elements of the array of data elements;
wherein the control circuit is operable to, in response to a request for/by an encoder of the two or more encoders to encode a compression block of the data array, wherein the request indicates an identifier identifying the compression block:
   implement the hash function to map the identifier identifying the compression block to a data element of the array of data elements;
   use a data value of the data element of the array of data elements to determine whether the request can be granted (whether the encoder can encode the compression block); and
   allow the request (allow the encoder to encode the compression block) when it is determined that the request can be granted (the encoder can encode the compression block).

Another embodiment of the technology described herein comprises a method of operating a data processing system or data processor, wherein the data processing system or data processor comprises:
two or more encoders operable to encode compression blocks of a data array; and
storage operable to store an array of data elements;
the method comprising, in response to a request for/by an encoder of the two or more encoders to encode a compression block of the data array, wherein the request indicates an identifier identifying the compression block:
   implementing a hash function to map the identifier identifying the compression block to a data element of the array of data elements;
   using a data value of the data element of the array of data elements to determine whether the request can be granted (whether the encoder can encode the compression block); and
   allowing the request (allowing the encoder to encode the compression block) when it is determined that the request can be granted (the encoder can encode the compression block).

These embodiments can, and in embodiments do, include any one or more or all of the optional features described herein, as appropriate. For example, only a maximum number of the two or more encoders may be allowed (by the control circuit) to encode a given compression block of the data array at any one time. The maximum number may be one or more. The data array may be an image array, e.g. frame for display.

An encoder may encode a compression block for any suitable reason. In embodiments, an encoder of the data processor (e.g. graphics processor) (requests to) encodes a compression block when the compression block is to be stored in the memory system in encoded (compressed) form. In embodiments, the data processor (e.g. graphics processor) caches compression block data in decoded form, and an encoder of the data processor (requests to) encodes a compression block that is cached by the data processor in decoded form when the compression block is to be evicted to a higher-level cache and/or the memory system in encoded form.

A (the) request may be issued whenever an encoder wants to encode a compression block. In embodiments, a (the) request is issued when (in response to) an encoder wants to encode a compression block, but where not all of the data to be encoded for that compression block is (currently) available to the encoder. Such a situation may occur, for example and in embodiments, where plural processing cores of a data processor can generate (e.g. different parts of) the same compression block, and each such processing core is associated with, e.g. comprises, a (respective) encoder, e.g. as described in United Kingdom Patent Application No. 2405981.8. In this case, in embodiments, in order to obtain all data to be encoded for a compression block, a “read-modify-write” process may be performed in which data for a compression block that an encoder of a processing core is “missing” is retrieved from the memory system and/or other processing cores/encoders.

Thus, in embodiments, a (the) data value of a data element of the array of data elements is used to determine whether an encoder can retrieve (any) missing data for a compression block it is to encode (and whether the encoder can encode the compression block), and the encoder is allowed to retrieve the missing data (and encode the compression block) when it is determined that the encoder can retrieve the missing data (and the compression block can be encoded). In embodiments, only a maximum number (e.g. one) of the two or more encoders is allowed (by the control circuit) to retrieve missing data for (and encode) a given compression block of the data array at any one time.

An (block-based) encoding scheme used by an encoder/processing circuit may be any suitable e.g. lossless or lossy compression scheme. For example, the encoding scheme may comprise Arm Frame Buffer Compression (AFBC), e.g. as described in US 2013/0036290 and US 2013/0198485, the entire contents of which is hereby incorporated by reference, or Arm Fixed Rate Compression (AFRC), e.g. as described in US 2021/0126736 and US 2022/0014767, the entire contents of which is hereby incorporated by reference. Other encoding schemes are possible.

An identifier identifying an item (e.g. compression block) can be any suitable such identifier. In embodiments, an (each) identifier identifying a (respective) processing item is a (respective) (memory) address for the item. For example, and in embodiments, encoded (compressed) data for each compression block of a data array may be stored (e.g. in the memory) at a respective memory address, e.g. that can be determined based on the position within the array that the respective compression block represents (e.g. as described in US 2013/0036290). Thus, an identifier identifying a compression block may be an (memory) address for the compression block.

The control circuit can be any suitable circuit that implements a hash function that maps identifiers identifying items (e.g. memory addresses for compression blocks) to data elements of an array of data elements stored in storage. There may be two or more different hash functions, e.g. one per data (e.g. image) array being processed. There may be two or more control circuits that implement the same or different hash functions. In embodiments, a (each) control circuit comprises (respective) storage storing an (the) array of data elements.

Thus, in embodiments, the storage is local storage (local to a control circuit). The storage may comprise any suitable form of storage, such as registers, cache, memory, etc.

A (the) hash function can be any suitable hash function that maps identifiers identifying the items (e.g. memory addresses for compression blocks) to data elements of the array of data elements. In embodiments, the hash function maps processing item identifiers (e.g. (memory) addresses) to positions (e.g. indexes) of the array of data elements. The hash function may uniformly map identifiers (e.g. (memory) addresses) to data elements (e.g. indexes) of the data array (e.g. such that substantially the same number of identifiers/processing items is mapped to each data element). Alternatively, the hash function may non-uniformly map identifiers to data elements of the data array (e.g. such that different numbers of identifiers/processing items are mapped to different data elements). The hash function, may for example, comprise one or more shift operations, and/or one or more XOR operations, and/or one or more other operations, etc.

An (the) array of data elements can be any suitable array. There may be two or more different arrays of data elements, e.g. one per data (e.g. image) array being processed. In embodiments, there are fewer data elements in an (the) array of data elements than there are processing items (that can be processed by the two or more processing circuits) associated with the array of data elements. For example, there may be fewer data elements in an (the) array of data elements than there are compression blocks in a data array (e.g. image array) being processed. This can (further) reduce storage requirements.

In this case, in embodiments, the hash function may map identifiers identifying two or more different processing items (e.g. compression blocks) to the same data element of the array of data elements. In embodiments, one or more, such as each, data element of the array of data elements may have two or more different (potential) identifiers (and thus items (e.g. compression blocks)) mapped to it by the hash function.

This may result in processing of an item of two or more items mapped to the same data element having to wait until processing of another item of the two or more items mapped to the same data element is complete. In embodiments, a number of data elements in the array of data elements is selected based on a rate at which such “collisions” are expected to occur. For example, more data elements may be selected to reduce the expected collision rate, and fewer data elements may be selected where a higher expected collision rate is acceptable. Similarly, the hash function may be configured to non-uniformly map identifiers to data elements of the data array such that an expected collision rate is different for different processing items.

In embodiments, a (the) control circuit is operable to control the two or more processing circuits (e.g. encoders) to allow a (each) processing circuit (e.g. encoder) to proceed with processing an item (e.g. encoding a compression block) or not. To facilitate this, the control circuit is in embodiments in communication with (each of) the two or more processing circuits (e.g. encoders).

In embodiments, the control circuit is operable to allow a (requesting) processing circuit (e.g. encoder) to process an item (e.g. encode a compression block) by signalling to the processing circuit (e.g. encoder) when it is determined that the processing circuit (e.g. encoder) can process the item (e.g. encode the compression block) (when it is determined that the request can be granted/allowed).

Thus, in embodiments, when it is determined (by the control circuit) that a request to process a processing item can be granted, the request is granted by (the control circuit) issuing a signal (to the requester) indicating that the request is granted/allowed. In embodiments, when it is determined (by the control circuit) that a request to process a processing item cannot be granted, the request is stalled, e.g. by (the control circuit) not issuing a signal indicating that the request is granted/allowed (e.g. until the request can subsequently be granted).

The control circuit uses data values of an (the (local)) array of data elements to determine whether to grant requests to process items. In embodiments, data values of an (the) array of data elements are therefore maintained appropriately (by the control circuit), e.g. to ensure that only a maximum number (e.g. one) of processing circuits can process a given item at any one time.

Thus, in embodiments, in response to a request to process a processing item being granted/allowed, a data value of a corresponding data element of the array of data elements is updated appropriately (by the control circuit). In embodiments, in response to a signal indicating that processing of a processing item is complete, a data value of a corresponding data element of the array of data elements is updated appropriately (by the control circuit). The appropriate data value/element of the array of data elements to update in response to a request/signal should be, and in embodiments is, identified by implementing a (the) hash function.

Data values of data elements of an (the) array of data elements may be maintained/updated (by the control circuit) in any suitable manner.

The control circuit may implement a mutex arrangement. In this case, in embodiments, the array of data elements is or comprises an array of bits. A bit value of a bit of the array of bits being a first value (e.g. 0) may indicate that a mutex for one or more corresponding processing items (e.g. compression blocks) is available to be acquired, and a bit value of a bit of the array of bits being a second value (e.g. 1) may indicate that a mutex for one or more corresponding processing items (e.g. compression blocks) is already acquired.

Thus, in embodiments, it is determined that a request to process an item can be granted when a (corresponding) bit value of a bit of the array of bits is a first value (e.g. 0), and it is determined that a request to process an item cannot be granted when a (corresponding) a bit value of a bit of the array of bits is a second value (e.g. 1).

Correspondingly, a bit value of each bit of the array of bits may be initialised to the first value (e.g. 0). Then, in embodiments, acquiring a mutex comprises setting a bit value of a bit of the array of bits to the second value (e.g. 1), and releasing a mutex comprises setting a bit value of a bit of the array of bits to the first value (e.g. 0). Thus, in embodiments, once it has been determined that a request to process an item can be granted, a (corresponding) bit value of a bit of the array of bits is set to the second value (e.g. 1). In embodiments, once processing of an item is complete, a (corresponding) bit value of a bit of the array of bits is set to the first value (e.g. 0).

In embodiments, in response to a signal indicating that processing of a processing item (e.g. encoding of a compression block) is complete, wherein the signal indicates an identifier identifying the processing item: the hash function is implemented to map the identifier identifying the item to a bit of the array of bits, and a bit value of the bit of the array of bits is set to the first value (e.g. 0) (by the control circuit).

Alternatively, the control circuit may implement a semaphore arrangement. In this case, in embodiments, the array of data elements is or comprises an array of counters. A counter value of a counter of the array of counters being less than a threshold value may indicate that a request to process an item (e.g. compression block) can be granted, and a counter value of a counter of the array of counters being greater than or equal to the threshold value may indicate that a request to process an item (e.g. compression block) cannot be granted. The threshold value may correspond to a maximum number of processes/processing circuits (e.g. encoders) that can process the same item at the same time.

Thus, in embodiments, it is determined that a request to process a processing item can be granted when a (corresponding) counter value of a counter of the array of counters is less than a threshold value, and it is determined that a request to process an item cannot be granted when a (corresponding) counter value of a counter of the array of counters is greater than or equal to the threshold value.

Correspondingly, a counter value of each counter of the array of counters may be initialised to an initial value (e.g. 0). Then, in embodiments, once it has been determined that a request to process an item can be granted, a (corresponding) counter value of a counter of the array of counters is incremented (e.g. by 1). In embodiments, once processing of an item is complete, a (corresponding) counter value of a counter of the array of counters is decremented (e.g. by 1).

In embodiments, in response to a signal indicating that processing of an item is complete, wherein the signal indicates an identifier identifying the item: the hash function is implemented to map the identifier identifying the item to a counter of the array of counters, and a counter value of the counter of the array of counters is decremented (by the control circuit).

The technology described herein can be implemented in any suitable system, such as a suitably operable micro-processor based system. In some embodiments, the technology described herein is implemented in a computer and/or micro-processor based system.

The various functions of the technology described herein can be carried out in any desired and suitable manner. For example, the functions of the technology described herein can be implemented in hardware or software, as desired. Thus, for example, the various functional elements, stages, units, and “means” of the technology described herein may comprise a suitable processor or processors, controller or controllers, functional units, circuitry, circuits, processing logic, microprocessor arrangements, etc., that are operable to perform the various functions, etc., such as appropriately dedicated hardware elements (processing circuits/circuitry) and/or programmable hardware elements (processing circuits/circuitry) that can be programmed to operate in the desired manner.

It should also be noted here that the various functions, etc., of the technology described herein may be duplicated and/or carried out in parallel on a given processor. Equally, the various processing stages may share processing circuits/circuitry, etc., if desired.

Furthermore, any one or more or all of the processing stages or units of the technology described herein may be embodied as processing stage or unit circuits/circuitry, e.g., in the form of one or more fixed-function units (hardware) (processing circuits/circuitry), and/or in the form of programmable processing circuitry that can be programmed to perform the desired operation. Equally, any one or more of the processing stages or units and processing stage or unit circuits/circuitry of the technology described herein may be provided as a separate circuit element to any one or more of the other processing stages or units or processing stage or unit circuits/circuitry, and/or any one or more or all of the processing stages or units and processing stage or unit circuits/circuitry may be at least partially formed of shared processing circuit/circuitry.

It will also be appreciated by those skilled in the art that all of the described embodiments of the technology described herein can include, as appropriate, any one or more or all of the optional features described herein.

The methods in accordance with the technology described herein may be implemented at least partially using software e.g. computer programs. Thus, further embodiments of the technology described herein comprise computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc.

The technology described herein also extends to a computer software carrier comprising such software which when used to operate a graphics processor, renderer or other system comprising a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus further embodiments of the technology described herein comprise computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

Embodiments of the technology described herein will now be described with reference to the drawings.

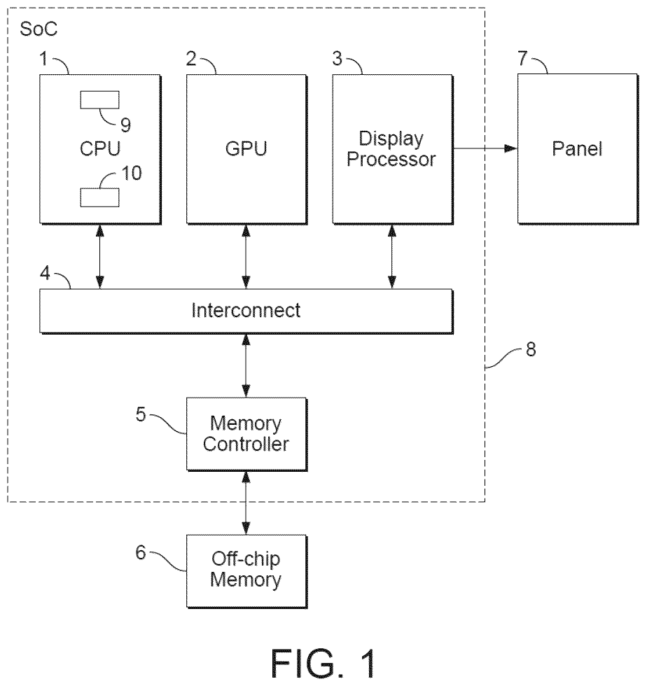

FIG. 1 shows an exemplary system on chip (SoC) graphics processing system 8 that comprises a host processor comprising a central processing unit (CPU) 1, a graphics processor (GPU) 2, a display processor 3, and a memory controller 5. As shown in FIG. 1, these units communicate via an interconnect 4 and have access to off-chip memory 6. In this system, the central processing unit (CPU) 1 and/or graphics processor 2 can generate data arrays, such as image arrays (frames) to be displayed, and the display processor 3 can provide such image arrays (frames) to a display panel 7 for display.

For example, an application 9 such as a game, executing on one or more host processors (CPUs) 1 may require the display of frames (images) on the display panel 7. To do this, the application may submit appropriate commands and data to a driver 10 for the graphics processor 2, e.g. that is executing on a CPU 1. The driver 10 may then generate appropriate commands and data for the graphics processor 2, and store those commands and data in the memory 6. The graphics processor 2 may read in the commands and data from the memory 6, process them to render appropriate frames (images) for display, and store the rendered frames (images) in the memory 6. The display processor 3 may then read the rendered frames (images) from the memory 6 and cause then to be displayed on the display panel 7 of the display.

Thus, data will be transferred between the memory 6 and the data processing units (e.g. CPU 1, GPU 2, display controller 3) of the data processing system. To reduce the amount of data that needs to be transferred to and from memory 6 during processing operations, the data may be stored in a compressed form in the memory 6.

As a data processing unit (e.g. CPU 1, GPU 2, display controller 3) will typically need to operate on the data in an uncompressed form, this accordingly means that data that is stored in the memory 6 in compressed form may need to be decompressed before being processed by the data processing unit. Correspondingly, data produced by a data processing unit may need to be compressed before being stored in the memory 6.

To facilitate this, a (and e.g. each) data processing unit (e.g. CPU 1, GPU 2, display controller 3) may be provided with one or more compression codecs that perform the required compression and/or decompression operations.

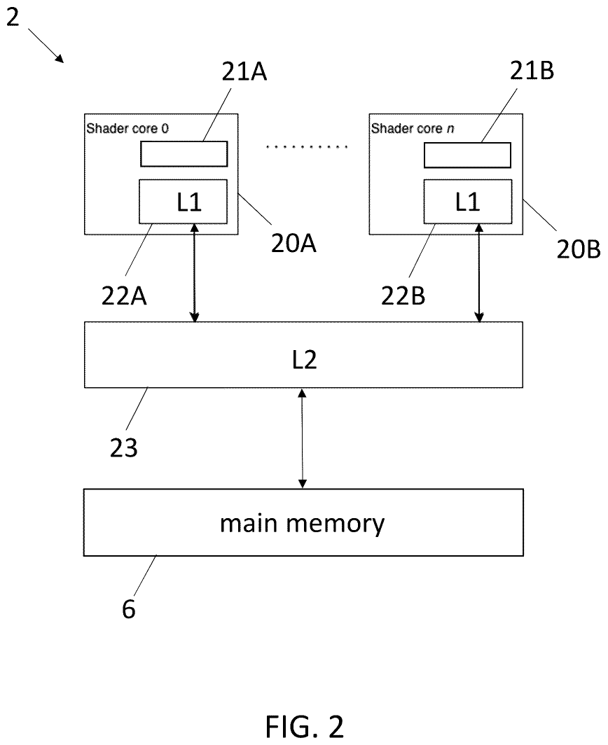

For example, FIG. 2 shows schematically a graphics processor (GPU) 2 in more detail. As shown in FIG. 2, the graphics processor 2 is a multi-core graphics processor 2 that includes plural processing cores (shader cores) 20A, 20B which are each operable to execute (shader) programs to perform processing operations. The plural processing cores (shader cores) 20A, 20B can work together to generate the same output data array, e.g. frame (image) for display. For example, each processing core (shader core) 20A, 20B may generate a respective region of an overall output data array (e.g. image array) being generated. FIG. 2 shows two shader cores 20A, 20B, but it will be appreciated that other numbers of shader cores are possible.

FIG. 2 also illustrates a cache system that is operable to transfer data from the memory system 6 to the processing cores (shader cores) 20A, 20B of the graphics processor 2, and conversely to transfer data produced by the processing cores 20A, 20B of the graphics processor 2 back to the memory 6. The cache system shown in FIG. 2 is illustrated as comprising two cache levels: each processing core (shader core) 20A, 20B of the graphics processor 2 has a respective (private) L1 cache 22A, 22B associated with it, and the cache system further comprise a (shared) L2 cache 23 that is closer to the memory 6 and in communication with the L1 caches 22A, 22B of all of the processing cores (shader cores) 20A, 20B of the graphics processor 2. Other caches and cache levels would be possible.

As shown in FIG. 2, to facilitate compression and decompression of data that passes between the memory 6 and the processing cores (shader cores) 20A, 20B, each processing core (shader core) 20A, 20B is provided with a respective compression codec 21A, 21B that can perform required compression and/or decompression operations.

In this system, data may be stored in memory 6 and cached in L2 cache 23 in compressed form, and cached in decompressed form in L1 cache 22A, 22B. The compression codecs 21A, 21B may accordingly be operable to encode (compress) data that is being evicted from the L1 level to the L2 level, and to decode (decompress) data that is fetched into the L1 level from the L2 level. Other arrangements are possible.

In the present embodiments, the compression codecs 21A, 21B are operable to perform block-based encoding (compression), in which a data array (e.g. image array) that the plural processing cores (shader cores) 20A, 20B are generating is divided into “blocks” of a particular size, and these compression blocks (compression units, “CU”), are encoded and decoded (compressed and decompressed) individually. Thus, the compression codec can take as an input a compression block of a particular data size (comprising data arrays of a particular size (W×H)), and compress the compression block to provide an output compressed block of data corresponding to the compression block. Correspondingly, the compression codec can decompress a compressed block of data to provide an output, decompressed block of image data. Encoded (compressed) data for each compression block of a data array may be stored in memory 6 at a respective memory address that e.g. can be determined based on the position within the data array that the respective compression block represents (e.g. as described in US 2013/0036290). A memory address for a compression block may, for example, be a (base) memory address of a header for the compression block.

In this system, it may typically be desirable to be able to ensure that only one of the plural compression codecs 21A, 21B of the graphics processor 2 can operate on any one compression block of a data array (e.g. image array) being generated by the processing cores (shader cores) at any one time. In particular, when a compression block of the data array is to be encoded by a compression codec 21A, 21B and evicted e.g. to the L2 level/memory 6, it will typically be desirable to prevent any other compression codec of the graphics processor 2 from attempting to encode (and evict) the same compression block at the same time.

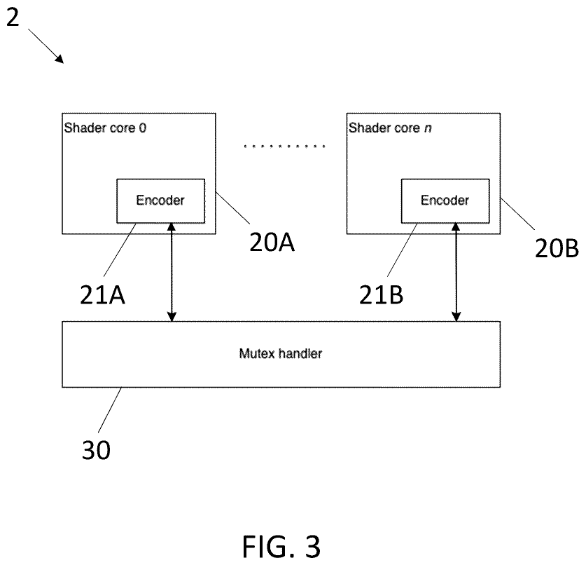

FIG. 3 shows a graphics processor 2 in accordance with embodiments of the technology described herein. FIG. 3 shows schematically elements of the graphics processor 2 that are relevant to the operation of the present embodiments. As will be appreciated by those skilled in the art there may be other elements of the graphics processor 2 that are not shown in FIG. 3. In particular, the graphics processor 2 of FIG. 3 may have a cache system etc., e.g. as described above with reference to FIG. 2.

As shown in FIG. 3, a mutex handler (control circuit) 30 is provided that is in communication with the compression codecs 21A, 21B of all of the processing cores (shader cores) 20A, 20B of the graphics processor 2. The mutex handler 30 is operable to effectively maintain a set of mutexes that includes a mutex for each compression block that a processing core (shader core) of the graphics processor 2 is generating data for. Each mutex can be assigned to only one compression codec of the graphics processor 2 at any one time, and the mutex handler 30 may keep track of the identity of the compression codec (if any) that each mutex is currently assigned to.

Before a compression codec 21A, 21B encodes (compresses) a compression block of a data array (e.g. image array) that the graphics processor 2 is generating, the compression codec must first acquire the mutex for that compression block from the mutex handler 30, and only once the compression codec has acquired the mutex for the compression block can the compression codec proceed with encoding (compressing) the compression block in question. Then, once the compression codec has completed the encoding (compression) of the compression block, the mutex for the compression block is released.

This can ensure that only one compression codec can encode (compress) any one compression block of the data array (e.g. image array) being generated at any one time.

In this arrangement, each compression block of a data array (e.g. image array) being generated by the graphics processor 2 may be identified by the respective (e.g. header) memory address at which encoded (compressed) data for the compression block will be (and is) stored in memory 6. Mutex handler 30 may then be implemented by maintaining a table of these memory addresses, wherein a memory address appearing in the table indicates that the mutex for the corresponding compression block has been acquired by a compression codec, and a memory address not appearing in the table indicates that the mutex for the corresponding compression block is available to be acquired by a compression codec.

The inventors have realised, however, that storing memory addresses in this manner may require that a relatively large amount of storage space is provided for this purpose. This can increase silicon/area costs associated with implementing mutex handling.

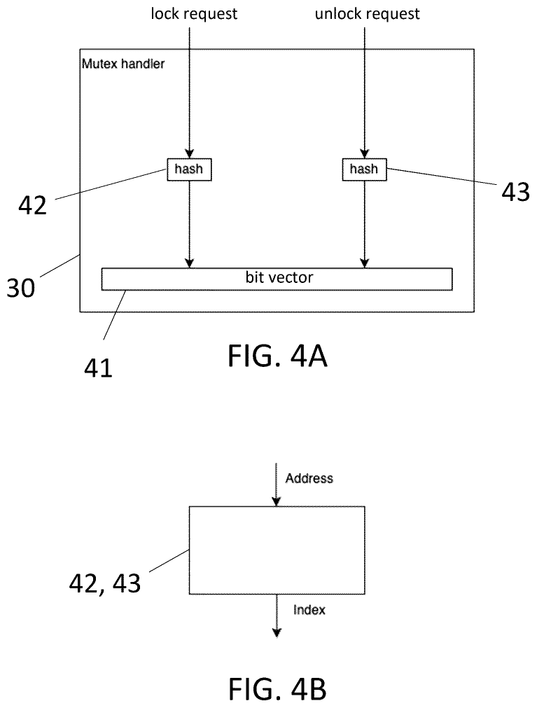

FIG. 4 illustrates an improved mutex handling arrangement in accordance with embodiments of the technology described herein. As illustrated in FIG. 4A, mutex handler 30 comprises storage 41 storing a bit vector, wherein each bit of the bit vector is associated with one or more corresponding compression blocks of a data array (e.g. image array) being generated by the graphics processor 2. A bit of the bit vector 41 being set (i.e. being 1) indicates that the mutex for the one or more associated compression blocks has been acquired by a compression codec, and a bit of the bit vector not being set (i.e. being 0) indicates that the mutex for the one or more associated compression blocks is available to be acquired by a compression codec. (Alternatively, a bit of the bit vector 41 not being set (i.e. being 0) may indicate that the mutex for the one or more associated compression blocks has been acquired by a compression codec, and a bit of the bit vector being set (i.e. being 1) may indicate that the mutex for the one or more associated compression blocks is available to be acquired by a compression codec.)

Each bit of the bit vector 41 is associated with one or more corresponding compression blocks of the data array via a hash function. As illustrated in FIG. 4A, the mutex handler 30 accordingly comprises one or more hash units 42, 43 that implement the (same) hash function. The mutex handler 30 shown in FIG. 4A has separate lock and unlock channels, and corresponding separate hash units 42, 43, but it would be possible to have a single, shared (lock and unlock) channel with a single hash unit.

FIG. 4B shows a hash unit 42, 43 in more detail. Hash unit 42, 43 implements a hash function that maps each compression block of a data array to a bit of the bit vector 41. In particular, as illustrated in FIG. 4B, the hash function maps an address identifying a compression block (a (e.g. header) memory address at which encoded (compressed) data for a compression block is stored in memory 6) to an index of the bit vector 41. Any suitable hash function may be used. Hash unit 42, 43 may, for example, implement a combinatorial network of shifts and XORs.

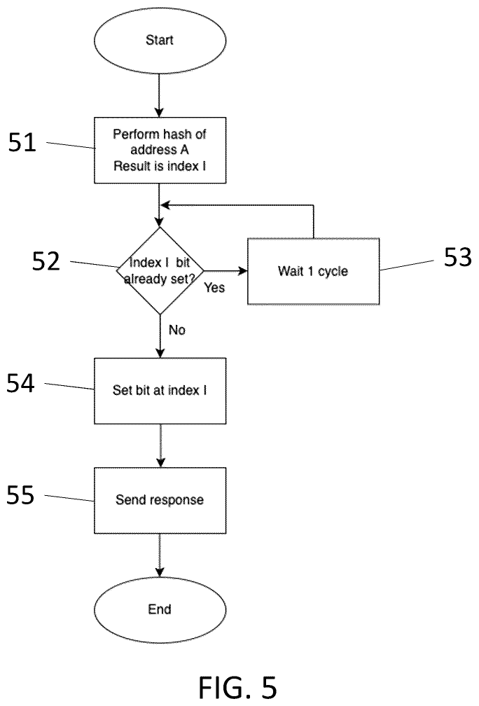

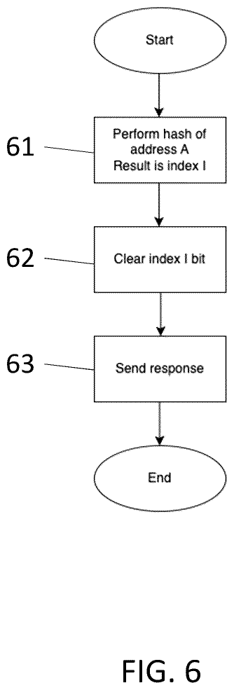

FIGS. 5 and 6 are flow charts illustrating lock and unlock requests in accordance with embodiments.

In the present embodiments, when graphics processor 2 begins generating a new data array (e.g. frame for display), each bit of bit vector 41 will initially be not set (i.e. 0) to indicate that all mutexes are initially available. Then, when a compression codec 21A, 21B of the graphics processor 2 wants to encode (compress) a compression block of the data array, the compression codec sends a lock request to the mutex handler 30, indicating an address of the compression block that the compression codec wants to encode.

As shown in FIG. 5, in response to the lock request, hash unit 42 applies the hash function to the address of the lock request to map the address to an index of the bit vector 41 (at step 51). Mutex handler 30 then determines whether or not the bit of bit vector 41 at the determined index is set (at step 52).

If (at step 52) the bit at the determined index is not set, that indicates that the mutex for the compression block is currently available. Thus, in this case, the bit at the determined index is set (at step 54) to indicate that the mutex is now in use, and the mutex handler 30 indicates to the compression codec that encoding of the compression block can proceed (at step 55).

On the other hand, if (at step 52) the bit at the determined index is set, that indicates that the mutex for the compression block is already in use. In this case, mutex handler 30 makes the compression codec wait (at step 53) until the bit at the determined index is not set (i.e. until the mutex for the compression block becomes available), and only then sets the bit (at step 54) and signals to the compression codec to proceed with encoding (at step 55).

Then, once the compression codec 21A, 21B of the graphics processor 2 has completed encoding (compressing) the compression block of the data array, the compression codec sends an unlock request to the mutex handler 30, indicating an address of the compression block that the compression codec has encoded.

As shown in FIG. 6, in response to the unlock request, hash unit 43 applies the hash function to the address of the unlock request to map the address to an index of the bit vector 41 (at step 61). Mutex handler 30 then clears the bit of bit vector 41 at the determined index (i.e. sets the bit to 0) to indicate that the mutex is now available (at step 62), and may indicate this to the compression codec (at step 63).

Bit vector 41 could comprise as many bits as there are compression blocks in a data array being generated. In this case, each bit of the bit vector 41 may have only one respective compression block of the data array mapped to it by the hash function. However, the inventors have recognised that it is possible to map more than one compression block to the same bit of the bit vector 41, and that this can (further) reduce storage requirements.

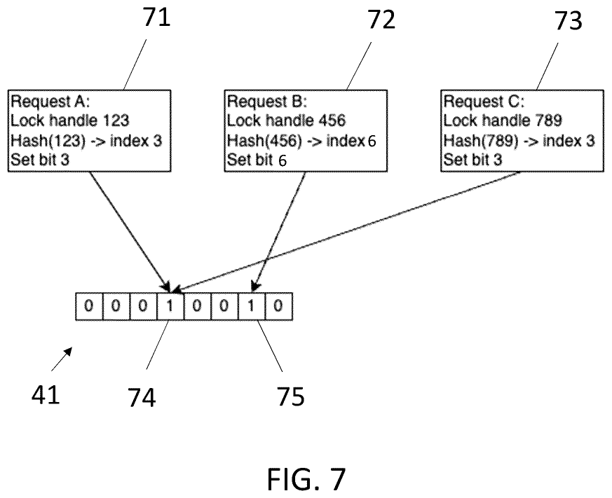

For example, FIG. 7 illustrates an embodiment in which the hash function maps plural compression blocks to the same bit of the bit vector 41, such that the number of bits of the bit vector 41 is less than the number of compression blocks in the data array.

In this example, all of the bits of the bit vector 41 are initially not set (i.e. 0). Then, mutex handler 30 receives a first lock request 71 to acquire a mutex for a first compression block identified by address “123”. In this example, the hash function maps address “123” to index “3”, and thus mutex handler 30 sets the bit 74 at index “3” of the bit vector 41 (to 1), and signals that encoding (compression) of the first compression block can proceed.

Mutex handler 30 then receives a second lock request 72 to acquire a mutex for a second compression block identified by address “456″. In this example, the hash function maps address “456″ to index ”6″, and thus mutex handler 30 sets the bit 75 at index ”6″ of the bit vector 41 (to 1), and signals that encoding (compression) of the second compression block can proceed.

As illustrated by FIG. 7, mutex handler 30 then receives a third lock request 73 to acquire a mutex for a third compression block identified by address “789”. In this example, the hash function maps address “789” to index “3”, i.e. the hash function maps the third compression block to the same bit in the bit vector 41 as the first compression block.

In this case, if, when the third lock request 73 is received, encoding of the first compression block has been completed, the bit 74 at index “3” of the bit vector 41 will have been cleared (to 0). Accordingly, in this case, the mutex handler 30 can set the bit 74 at index “3” (to 1), and signal that encoding (compression) of the third compression block can proceed.

If, however, when the third lock request 73 is received, encoding of the first compression block has yet to be been completed, the bit 74 at index “3” of the bit vector 41 will still be set (to 1). Accordingly, in this case, the mutex handler 30 will wait until the bit 74 at index “3” is cleared (to 0), before (re-)setting the bit 74 at index “3” (to 1), and signalling that encoding (compression) of the third compression block can proceed. Thus, in this case, encoding of the third compression block will have to wait until encoding of the first compression block is completed.

Accordingly, mapping more than one compression block to the same bit of the bit vector 41 may lead to “collisions” between different compression blocks.

The inventors have found, however, that in many situations, the benefits associated with reduced storage requirements for the bit vector 41 can outweigh costs associated with this collision risk. Moreover, the number of bits in the bit vector 41 can be tailored to achieve an acceptable “collision rate”, i.e. more bits may be provided to reduce the expected collision rate, and fewer bits may be provided where a higher expected collision rate is acceptable.

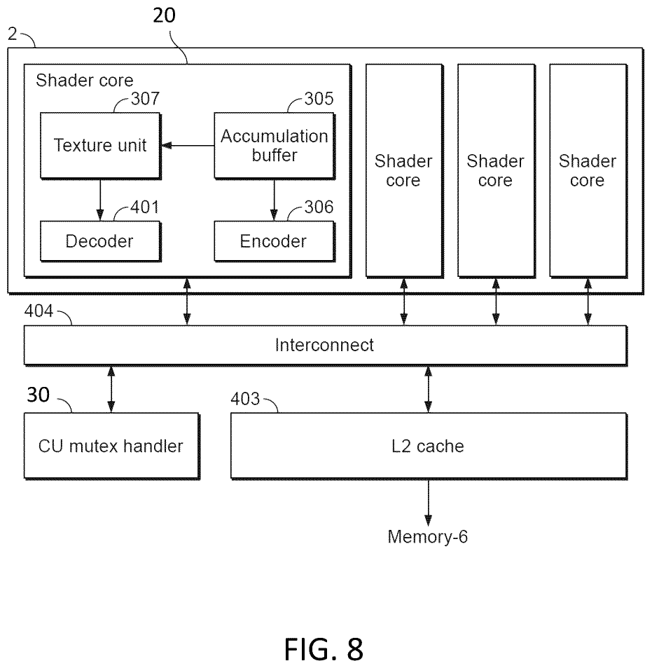

FIGS. 8, 9 and 10 illustrate an embodiment in more detail, in which graphics processor 2 is a tile-based graphics processor arranged substantially as described in United Kingdom Patent Application No. 2405981.8. As shown in FIG. 8, the graphics processor 2 of this embodiment comprises a plurality of shader cores 20, with each shader core 20 having its own respective texture unit 307, encoder 306, decoder 401 and accumulation buffer 305.

In this embodiment, texture unit (texture mapper) 307 is operable to perform texturing operations on texture data stored in the memory system 6, and decoder 401 is operable to decode data that is stored in a compressed form in the memory for provision to the texture unit 307. Encoder 306 is a block-based encoder that is operable to encode (compress) compression blocks of output data generated by the shader core 20 prior to outputting that data to the memory 6 (via the L2 cache 403), and accumulation buffer 305 is operable to accumulate “complete” compression blocks of output data to be encoded by the encoder 306.

As shown in FIG. 8, the encoder 306 and texture unit 307 of each shader core 20 are operable to and configured to communicate with the memory system 6 via an appropriate cache hierarchy, including an L2 cache 403. An appropriate interconnect 404 is provided to allow the shader cores to communicate with the L2 cache 403 and thus the memory 6.

FIG. 8 also shows a mutex handler 30 that is in communication with the shader cores 20 of the graphics processor. The mutex handler 30 is operable as described above to maintain mutexes for compression blocks that shader cores 20 of the graphics processor 2 are currently generating data for.

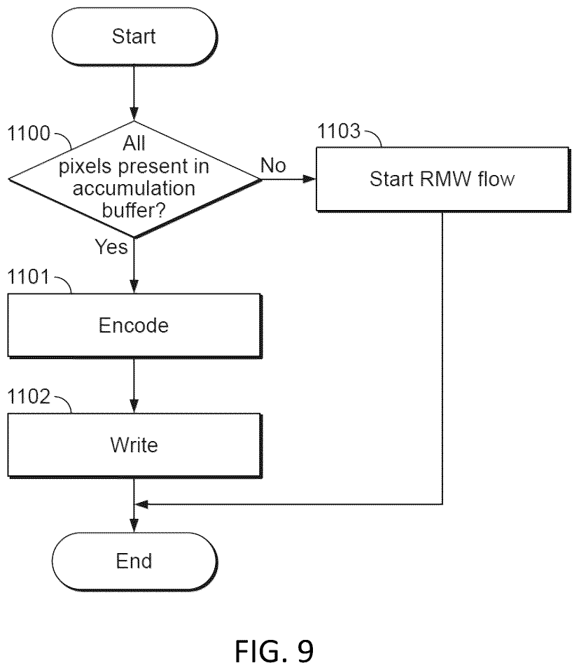

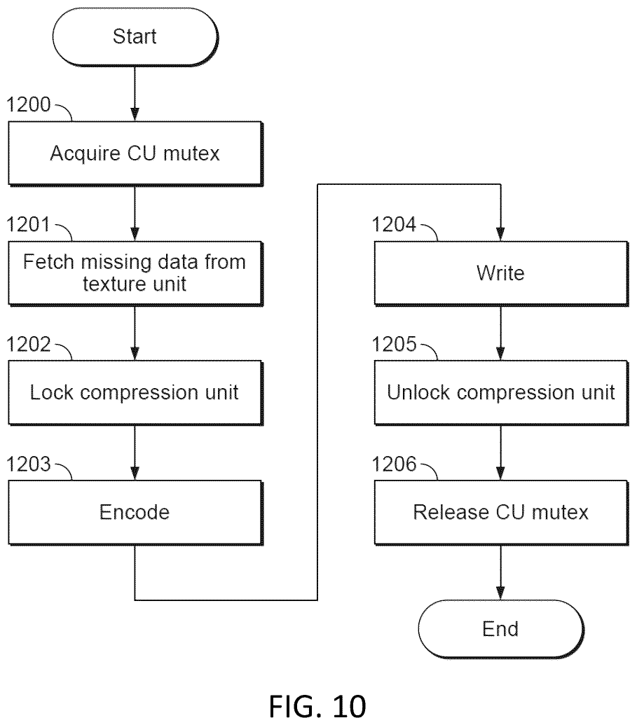

In this embodiment, an encoder 306 of a shader core 20 is triggered to encode (compress) and output a compression block of data to memory 6 when the last pixel for the compression block has been generated by the shader core 20 and received by the accumulation buffer 305. This compression block “eviction” process is illustrated by FIGS. 9 and 10.

As shown in FIG. 9, the eviction process first determines whether all the pixels for the compression block in question are present in the accumulation buffer 305 (step 1100). If so, then the pixels for the compression block are sent from the accumulation buffer 305 to the encoder 306, which operates to encode (compress) the compression block (step 1101) and then write the compressed block of data to the memory system 6 (step 1102).

On the other hand, and as shown in FIG. 9, when it is determined that not all pixels for the compression block are present in the accumulation buffer 305 (for the shader core 20 in question), a “read-modify-write” flow is performed (step 1103) to enable the encoder 306 to still be provided with a “complete” compression block for compressing. FIG. 10 shows this read-modify-write flow in more detail.

In this embodiment, different shader cores 20 of the graphics processor 2 can generate tiles for different parts of the same compression block. It is therefore desirable to ensure that only one accumulation buffer has access to a compression block for performing a read-modify-write operation at any one time. Thus, as shown in FIG. 10, at the start of the read-modify-write flow, the accumulation buffer 305 first acquires a (global) mutex for the compression block in question from the mutex handler 30 (step 1200) (e.g. as described above with reference to FIG. 5). This is to ensure that only one accumulation buffer at any one time is performing a read-modify-write operation on a given compression block for a render output.

Once the compression block mutex has been acquired, the accumulation buffer 305 then signals the texture unit (texture mapper) 307 to fetch the data that it does not have for the compression block in question (the “missing” compression block data) from the memory system 6 (step 1201).

The compression block in question is then “locked”, so as to prevent all other texture mappers in the graphics processor 2 from reading the data of the compression block that is being encoded. This is done by invalidating any and all data related to the compression block in question in all texture mappers in the GPU 2 (such that they will not use any cached data for the compression block in question).

Once the texture unit 307 has acquired the missing data from the memory system and provided it to the accumulation buffer 305, the accumulation buffer 305 then provides the complete compression unit to the encoder 306 which then encodes the compression block (step 1203) and writes the compression block to the memory system 6 (step 1204).

Once the compression block has been written to the memory system 6, then the compression block can be “unlocked”, so that texture mappers are able to read the compression block (from the memory system) (step 1205). The compression block mutex is then released (step 1206) (e.g. as described above with reference to FIG. 6). Another accumulation buffer (shader core) can then perform a read-modify-write process for the compression block, if required.

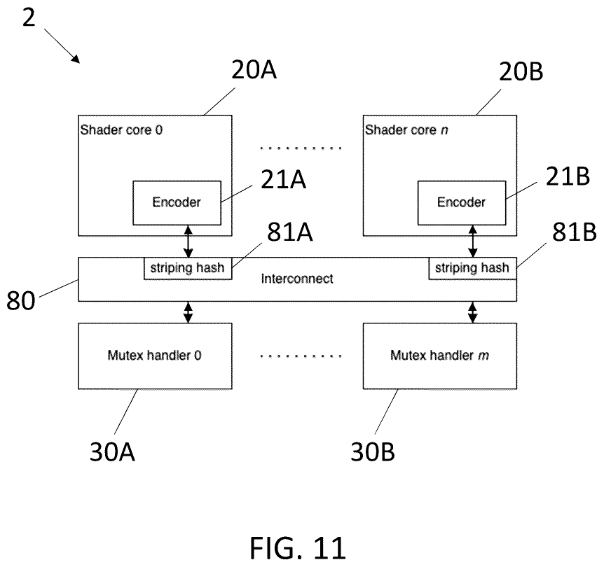

Although in the above embodiments, there is a single mutex handler 30 that handles all of the mutexes, other arrangements are possible. For example, FIG. 11 illustrates another embodiment in which plural mutex handlers 30A, 30B are provided, with each mutex handler handling a respective subset of mutexes. FIG. 11 shows two mutex handlers 30A, 30B, but it will be appreciated that other numbers of mutex handlers are possible.

As shown in FIG. 11, in this embodiment, the plural mutex handlers 30A, 30B are in communication with the plural compression codecs 21A, 21B of the graphics processor 2 via an interconnect 80, and a striping hash 81A, 81B (which may implement a different hash function to hash unit 42, 43) is used to route a request from a compression codec for a mutex to the mutex handler that is handling that particular mutex. Other arrangements are possible.

Although the above embodiments relate to handling mutexes to control processing of compression blocks of a data array, other embodiments relate to controlling processing of other types of processing items/resources. Similarly, although the above embodiments relate to handling mutexes to prevent more than one compression codec of a graphics processor processing the same item (compression block) at the same time, other embodiments relate controlling other processes and processing units. For example, CPU 1 may implement mutex handling in a corresponding manner.

Thus, in embodiments, mutex handling is implemented using a hash function that maps identifiers for items to bits of a bit vector, wherein each bit of the bit vector is used to determine whether a process is allowed to process one or more items mapped to the respective bit.

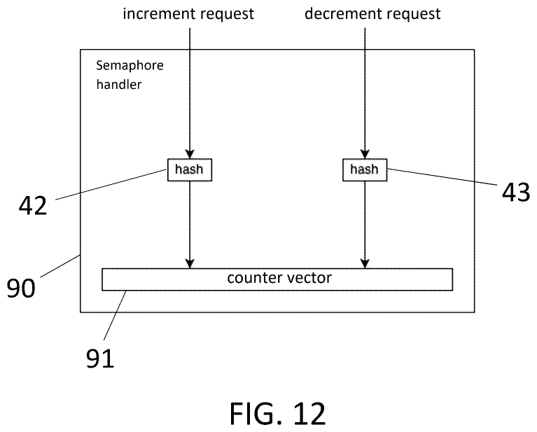

Although the above embodiments relate to mutex handling, semaphores may also be handled in a corresponding manner. For example, FIG. 12 shows a semaphore handler (control circuit) 90 in accordance with embodiments of the technology described herein. The semaphore handler 90 is arranged and operates in substantially the same manner as the mutex handler 30 described above, and only the main differences will now be described.

As illustrated in FIG. 12, semaphore handler 90 comprises storage 91 storing a set of counters, wherein each counter of the set of counters is associated, via a hash function, with one or more corresponding processing items. In this embodiment, when a process wants to process a processing item, hash unit 42 applies a hash function to an identifier for the processing item to map the identifier to a counter of the set of counters 91, and that counter is incremented. When a process indicates that it no longer wants to process (e.g. has finished processing) a processing item, hash unit 43 applies the hash function to an identifier for the processing item to map the identifier to a counter of the set of counters 91, and that counter is decremented.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A data processing system comprising:
two or more processing circuits operable to process items of a set of items;
storage operable to store an array of data elements; and
a control circuit operable to implement a hash function that is configured to map identifiers identifying items of the set of items to data elements of the array of data elements;
wherein the control circuit is operable to, in response to a request for a processing circuit of the two or more processing circuits to process an item of the set of items, wherein the request indicates an identifier identifying the item:
implement the hash function to map the identifier indicated by the request to a data element of the array of data elements;
use a data value of the data element of the array of data elements to determine whether the processing circuit can process the item; and
allow the processing circuit to process the item when it is determined using the data value that the processing circuit can process the item.

2. The system of claim 1, wherein the two or more processing circuits are operable to perform block-based encoding;
wherein the items of the set of items are compression blocks of a data array that can be encoded by the two or more processing circuits;
wherein the control circuit is operable to, in response to a request for a processing circuit of the two or more processing circuits to encode a compression block of the data array, wherein the request indicates an identifier identifying the compression block:
implement the hash function to map the identifier indicated by the request to a data element of the array of data elements;
use a data value of the data element of the array of data elements to determine whether the processing circuit can encode the compression block; and
allow the processing circuit to encode the compression block when it is determined using the data value that the processing circuit can encode the compression block; and
wherein the control circuit is operable to allow a maximum number of the two or more processing circuits to encode a given compression block of the data array at any one time.

3. The system of claim 1, wherein an identifier identifying an item is a memory address for the item.

4. The system of claim 1, wherein there are fewer data elements in the array of data elements than there are items in the set of items, and wherein the hash function is configured to map identifiers identifying two or more different items of the set of items to the same data element of the array of data elements.

5. The system of claim 1, wherein the array of data elements is an array of bits, and the control circuit is operable to:
determine that a processing circuit can process an item when a bit value of a bit of the array of bits is a first value; and
determine that a processing circuit cannot process an item when a bit value of a bit of the array of bits is a second value.

6. The system of claim 5, wherein the control circuit is operable to, once it has been determined that a processing circuit can process an item, set a bit value of a bit of the array of bits to the second value.

7. The system of claim 5, wherein the control circuit is operable to, in response to a signal indicating that processing of an item is complete, wherein the signal indicates an identifier identifying the item:
implement the hash function to map the identifier indicated by the signal to a bit of the array of bits; and
set a bit value of the bit of the array of bits to the first value.

8. The system of claim 1, wherein the array of data elements is an array of counters, and the control circuit is operable to:
determine that a processing circuit can process an item when a counter value of a counter of the array of counters is less than a threshold value; and
determine that a processing circuit cannot process an item when a counter value of a counter of the array of counters is greater than or equal to the threshold value.

9. The system of claim 8, wherein the control circuit is operable to, once it has been determined that a processing circuit can process an item, increment a counter value of a counter of the array of counters.

10. The system of claim 8, wherein the control circuit is operable to, in response to a signal indicating that processing of an item is complete, wherein the signal indicates an identifier identifying the item:
implement the hash function to map the identifier indicated by the signal to a counter of the array of counters; and
decrement a counter value of the counter of the array of counters.

11. A method of operating a data processing system that comprises:
two or more processing circuits operable to process items of a set of items; and
storage operable to store an array of data elements;
the method comprising, in response to a request for a processing circuit of the two or more processing circuits to process an item of a set of items, wherein the request indicates an identifier identifying the item:
implementing a hash function to map the identifier indicated by the request to a data element of the array of data elements;
using a data value of the data element of the array of data elements to determine whether the processing circuit can process the item; and
allowing the processing circuit to process the item when it is determined using the data value that the processing circuit can process the item.

12. The method of claim 11, wherein:
the two or more processing circuits are operable to perform block-based encoding;
the items of the set of items are compression blocks of a data array that can be encoded by the two or more processing circuits; and
the method comprises, in response to a request for a processing circuit of the two or more processing circuits to encode a compression block of the data array, wherein the request indicates an identifier identifying the compression block:
implementing a hash function to map the identifier indicated by the request to a data element of the array of data elements;
using a data value of the data element of the array of data elements to determine whether the processing circuit can encode the compression block; and
allowing the processing circuit to encode the compression block when it is determined using the data value that the processing circuit can encode the compression block;
wherein a maximum number of the two or more processing circuits is allowed to encode a given compression block of the data array at any one time.

13. The method of claim 11, wherein an identifier identifying an item is a memory address for the item.

14. The method of claim 11, wherein there are fewer data elements in the array of data elements than there are items in the set of items, and wherein the hash function is configured to map identifiers identifying two or more different items of the set of items to the same data element of the array of data elements.

15. The method of claim 11, wherein the array of data elements is an array of bits, and the method comprises:
determining that a processing circuit can process an item when a bit value of a bit of the array of bits is a first value; and
determining that a processing circuit cannot process an item when a bit value of a bit of the array of bits is a second value.

16. The method of claim 15, comprising once it has been determined that a processing circuit can process an item, setting a bit value of a bit of the array of bits to the second value.

17. The method of claim 15, comprising in response to a signal indicating that processing of an item is complete, wherein the signal indicates an identifier identifying the item:
implementing the hash function to map the identifier indicated by the signal to a bit of the array of bits; and
setting a bit value of the bit of the array of bits to the first value.

18. The method of claim 11, wherein the array of data elements is an array of counters, and the method comprises:
determining that a processing circuit can process an item when a counter value of a counter of the array of counters is less than a threshold value; and
determining that a processing circuit cannot process an item when a counter value of a counter of the array of counters is greater than or equal to the threshold value.

19. The method of claim 18, comprising:
once it has been determined that a processing circuit can process an item, incrementing a counter value of a counter of the array of counters; and
in response to a signal indicating that processing of an item is complete, wherein the signal indicates an identifier identifying the item:
implementing the hash function to map the identifier indicated by the signal to a counter of the array of counters; and
decrementing a counter value of the counter of the array of counters.

20. (canceled)

21. A non-transitory computer readable storage medium storing software code which when executing on a processor performs a method of operating a data processing system as claim in claim 11.

22. A data processor comprising:
two or more processing circuits operable to process items of a set of items;
storage operable to store an array of data elements; and
a control circuit operable to implement a hash function that is configured to map identifiers identifying items of the set of items to data elements of the array of data elements;
wherein the control circuit is operable to, in response to a request for a processing circuit of the two or more processing circuits to process an item of the set of items, wherein the request indicates an identifier identifying the item:
implement the hash function to map the identifier indicated by the request to a data element of the array of data elements;
use a data value of the data element of the array of data elements to determine whether the processing circuit can process the item; and
allow the processing circuit to process the item when it is determined using the data value that the processing circuit can process the item.
